(19) United States
(12) Patent Application Publication
(10) Pub. No.: US 2019/0264088 A1
(43) Pub. Date: Aug. 29, 2019

(54) METHOD FOR ENHANCING METAL CORROSION INHIBITION IN OIL AND NATURAL GAS PRODUCTION

(71) Applicant: TouGas Oilfield Solutions GmbH, Frankfurt am Main (DE)

(72) Inventors: Benjamin Gerlach, Aschaffenburg (DE); Fatima Dugonjio-Bilic, Offenbach (DE); Jasmin Meurer, Mainz (DE); Marita Neuber, Dreieich (DE)

(21) Appl. No.: 16/345,788

(22) PCT Filed: Oct. 20, 2017
(86) PCT No.: PCT/EP2017/076841

§ 371 Date: Apr. 29, 2019

(30) Foreign Application Priority Data
Oct. 31, 2016 (EP) 16196508.2

(51) Int. Cl. C09K 8/54; C09K 8/74; C23F 11/04; C23F 11/12; C23F 11/173

(52) U.S. Cl. CPC C09K 8/54; C09K 8/74; C09K 2208/32; C23F 11/122; C23F 11/173; C23F 11/04

(57) ABSTRACT

The use of synthetic polymer in combination with an organic corrosion inhibiting compound having at least one unsaturated carbon-carbon bond, preferably selected from the group of acetylenic alcohols, α,β-unsaturated aldehydes, and/or α-alkenyl phenones, reduces or inhibits corrosion of metal equipment present during acidizing treatment in gas- or oilfield reservoirs with one or more acids. Also disclosed is a method for reducing or inhibiting corrosion of steel equipment present during an acid treatment of a gas- or oilfield reservoir with one or more acids by using a specific synthetic polymer as corrosion inhibitor in combination with an organic corrosion inhibiting compound having at least one unsaturated carbon-carbon bond, preferably selected from the group of acetylenic alcohols, α,β-unsaturated aldehydes, and/or α-alkenyl phenones.

The resources for fossil fuels are highly exploited and limited. With new and improved technologies, these resources for oil and natural gas can be further exploited and unconventional reservoirs can be accessed. With the increasingly challenging conditions for the oil and gas production, the requirements for the equipment and the chemicals also become more and more demanding.

Several techniques are used to increase oil and natural gas production from formations with low permeability or from exploited oil and gas field. In sandstone and especially in carbonate reservoirs acid treatment—that means that acid is pumped down into the borehole—is a widely used technique either to stimulate a well to improve flow or to remove damage. Formation fines, mud or cement filtrate, scale from well operations that is accumulated in the tubing, in the perforations and the area immediate to the well bore may be removed by purging the well with acid. Typically, this is done by means of coiled tubing. Acid is pumped down the well and the spent acid is returned through the annulus of the coiled tubing.

There are two types of acid treatment of the formation that are related to injection rates and pressures. Injection rates resulting in pressures below fracture pressure are termed “matrix acidizing”, while those above fracture pressure are termed “fracture acidizing” or “acid fracturing”.

During “matrix acidizing” the acids dissolve the sediments of the reservoir and of mud solids within the pores that are inhibiting the permeability of the rock. This process enlarges the natural pores of the reservoir, which stimulates the flow of hydrocarbons. Removal of severe plugging of the pores can result in very large increases in well productivity. The acid also dissolves rock matrix leading to the formation of highly conductive flow channels, the so-called wormholes.

In “acid fracturing” highly conductive fractures and long wormholes are created by pumping acid at pressures exceeding the minimum stress of the formation. When fractures in the formation are opened due to the high pressure the acid enters these newly formed fractures and etches channels on the fracture surface. The acid is also pressed further into the formation forming a network of wormholes. When the pressure is released and the fractures close again the etched channels and wormholes stay open. No proppants are necessary to keep the paths for oil and gas opened. Acid fracturing is typically used in formations with low permeability and in carbonates.

The temperatures for acidizing treatments is normally in the range from slightly above ambient temperature for low depth wells up to about 100° C., in special cases even up to 150° C. or higher.

Hydrochloric acid (HCl) is mostly used for acid treatments in carbonate reservoirs. HCl is highly reactive with carbonates and the salts from its reaction with the rock are typically water soluble and thus easy to remove from the borehole. HCl is not expensive and easily available. However, HCl can react so fast that large wormholes are created through which the acid flows with ease etching even larger channels and increasing its leak off but leaving most parts of the formation unstimulated. Methods were developed to control the placement of acid and its reactivity, for example pumping viscous fluid pads intermittently throughout the acid treatment. The viscous fluid forms a filter cake that is a temporary barrier against the acid leak-off. Another method is to make the acid more viscous by either applying emulsified acid or gelled acid. Typically, the reactivity of the acid is also influenced and the activity is retarded. Often HCl is used together with other acids, e.g. with hydrofluoric acid (HF) or organic acids like acetic acid or formic acid.

Since HCl or its mixtures with other acids are highly corrosive against steel equipment, especially at higher temperatures, corrosion inhibitors must be used to protect the tubulars from corrosive attack.

A broad variety of chemicals were tested for their capability to prevent corrosion of steel. Amongst them, propargyl alcohol, substituted benzimidazoles, benzyl alkyl pyridine quat, benzalkonium chloride and cinnamaldehyde were the most effective substances, see for example “Application of corrosion inhibitors for steels in acidic media for the oil and gas industry: A review”, M. Finsgar, J. Jackson, Corrosion Science 86 (2014) 17-41.

Furthermore, it is well known that combinations of various corrosion inhibiting compounds as well as combinations of corrosion inhibiting compound with special chemicals may increase the inhibition effectiveness.

U.S. Pat. No. 3,773,465 claims the use of acetylenic compounds or nitrogen compounds or mixtures thereof in combination with CuI. The presence of CuI improves the corrosion inhibition effect compared to the use of acetylenic compounds or nitrogen compounds or their mixtures alone. Inorganic and organic acids inhibited by the described mixtures can be used from 65° C. (150° F.) to about 232° C. (450° F.).

U.S. Pat. No. 4,614,600 describes an anti-corrosive composition which comprises the condensate of a polyamine such as diethylene or triamine triethylenetetramine with a 21 or 22 carbon fatty polycarboxylic acid or acid anhydride that shows synergistic corrosion inhibition effect when mixed with propargyl alcohol.

U.S. Pat. No. 4,557,838 claims an admixture of synergistic additives consisting essentially of (1) a heterocyclic nitrogen compound or alkylamine, (2) an acetylenic alcohol, and (3) a dialkylthiourea as corrosion inhibitor formulation.

In U.S. Pat. No. 4,734,259 a composition for inhibiting the attack of aqueous corrosive fluids on metal including an α,β-unsaturated aldehyde and a surfactant is described. It is stated that aldehyde and surfactant containing corrosion inhibiting compositions provide greater and more reliable corrosion inhibition than do compositions containing the aldehyde alone.

Barmatov et al. investigated corrosion effectiveness of mixtures of acetylenic alcohols with quaternary ammonium cations and found strong synergistic behavior especially for 4-ethyl-1-octyn-3-ol and n-dodecylpyridinium chloride (NACE 2012, C2012-0001573).

Due to the manifold and pronounced interactions of various individual corrosion inhibiting substances typically corrosion inhibitor packages consisting of several components are used for acidizing operations.

Beside the aforementioned substances, also polymeric corrosion inhibitors have been considered. Due to their less toxic properties, polymers were tested for their capability to prevent or reduce corrosion. A broad variety of different metals is used for the examination and often aqueous system and not acidic systems are investigated. Thus, Umoren et al. al reported that polyvinylpyrrolidone in 1 molar H₂SO₄ reduces corrosion on mild steel more effectively than polyacrylamide (Umoren S. A. et al., Surf. Rev. Lett. 2008, 25 (3), 277). Selvaraji et al. examined the influence of polyvinylpyrrolidone on carbon steel in aqueous system in the presence and absence of 60 ppm chloride ion and zinc ion (Selvaraji S. K. et al., Corrosion Rev., 2004, 22(3), 219).

In U.S. Pat. No. 8,372,336 the use of product obtainable by the reaction of an alkoxylated fatty amine with a dicarboxyic acid derivative, followed by partial or total quaternization of the reaction product obtained, is described. The product consists of >50% w/w of oligomers/polymers based on alkoxylated amine and dicarboxylic acids and is used as a corrosion inhibitor for metal surfaces.

In U.S. Pat. No. 4,650,591 a method of inhibition corrosion and scale formation in aqueous solution using at least 0.1 mg/I of a polymer consisting of 35 to 65% by weight of acrylic acid or methacrylic acid, 15 to 45% by weight of 2-acrylamido-2-methylpropylsulfonic acid and 15 to 25% by weight of 2-acrylamido-2-methylpropylphosphonic acid is described. In the method, the polymer is only applied in aqueous system and not in acidic media.

Chinese Patent Application CN 105001366 discloses a copolymer of acrylamide and acrylic acid as corrosion inhibitor for wastewater from industry, steel plant, electroplating plant, metallurgy, and sewage plant

In summary, often polymers are used to protect water treatment equipment against corrosion caused by the water or to prevent corrosion from diluted acid. For acidizing treatment in oil or gas field operations the use of acids with high concentration is necessary.

However, polymers are well known in oil or gas field operations and can act as thickener for aqueous acids (acid gellant). The polymers can be natural based polymers or synthetic polymers.

Typically, as natural based polymers, polysaccharides or modified polysaccharides are used. For instance, suitable hydratable polysaccharides include starch or its derivatives, galactomannan gums, glucomannan gums, cellulosic derivatives, preferably carboxymethyl cellulose; cellulose ether, preferably hydroxyethyl cellulose; guar gums or its derivatives, preferably hydroxyalkyl guar, carboxyalkyl guar, and carboxyalkyl hydroxyalkyl guar or hydrophobically modified guar alginates, carrageenans, tragacanth gums, glucan gums and xanthan gums. All the natural based polymers have in common that due to their glycosidic bonds they are not stable at elevated temperatures and under highly acidic conditions. Thus, the ability to gel acids may last only for a very short/limited time and such short/limited periods are problematic in such operations. Furthermore, the availability of natural based polymers may depend on weather conditions and crop yield. This dependence affects the availability and the price of natural based polymers.

In response to such problems of natural based polymers, synthetic polymers based on acrylamide are used for acidizing applications in the oil and gas production as substitutes for natural based polymers. Synthetic polymers are independent from bad weather conditions and distinguish themselves with marked better temperature and chemical stability. For example, acrylamide can be copolymerized with a broad variety of monomers to adjust the properties of the resulting water soluble polymer. Amongst others, ethylenically unsaturated carboxylic, sulfonic or phosphonic acids, their esters, unsubstituted or N- and N,N-substituted derivatives of amides of ethylenically unsaturated carboxylic acids, N-substituted (cyclic) derivatives of ethylenically unsaturated amides can be used.

The viscosity of acids containing polymers as thickener can be further increased by crosslinking the polymer chains to form a hydrogel, that is a three dimensional network of extremely high molecular weight. Typically, polyvalent cations of group IIIA, IVB, VB, VIB, VIIB and/or VIIIB of the periodic table of the elements are used as crosslinking compound in acids, preferred are compounds of zirconium, titanium or iron, The viscosity of the viscosified acids or of the crosslinked acidic hydrogels may range from almost as thin as water (1 mPas) up to 5000 mPas. The application of polyacrylamide based polymers as thickener for aqueous acids is widely described in the literature. For example, U.S. Pat. No. 4,244,826 discloses the use of polymers as partially hydrolyzed polyacrylamide as gellant for aqueous acids to be used for acidizing a subterranean formation; U.S. Pat. No. 5,975,206 discloses the use of a polymer emulsion containing a polymer consisting of acrylamide and 2-acrylamido-2-methylpropane sulfonic acid; the polymer is applied in acid together with an external activator and crosslinked with zirconium compound to form the gelled acid; EP-A-0,112,520 discloses the use of metal chelates of water soluble copolymers consisting of monomers carrying at least a carboxylic acid amide group, a sulfonic acid group and a phosphonic acid group as gellant for aqueous acids; U.S. Patent Publication 2003-0104948 describes a gellant for acid consisting of acrylamide and/or acrylic acid that is copolymerized with the dimethylaminoalkyl derivatives of acrylamide and/or acrylic acid.

The effectiveness of corrosion inhibitors strongly depends on the applied conditions and the kind of steel that has to be protected from acidic attack. Individual selection of corrosion inhibitors for every individual application is necessary. Therefore, there is an existing need for corrosion inhibitors that reduce the complexity of their use and which are still effective over a broad range of conditions like temperature and acid concentrations to protect a broad variety of steel qualities in the severe conditions existing during such oil or gas field operations.

Surprisingly it was found, that the use of mixtures consisting of synthetic polymers typically used as thickener for aqueous acids and compounds often used in corrosion inhibitor formulations like acetylenic alcohols, α,β-unsaturated aldehydes, and/or α-alkenyl phenones provide enhanced corrosion inhibition effectiveness than do compositions either with synthetic polymers or individual corrosion inhibitor compounds alone. Thus one can say that such mixtures provide a synergistic effect.

Therefore, the present invention relates to the use of an aqueous mixture comprising
(i) water and a (ii) mixture consisting of
(iia) water soluble synthetic polymer comprising ethylenically unsaturated carboxylic, sulfonic or phosphonic acids, their esters, unsubstituted or N- and N,N-substituted derivatives of amides of ethylenically unsaturated carboxylic acids, N-substituted (cyclic) derivatives of ethylenically unsaturated amides and
(iib) at least of one organic compound having at least one unsaturated carbon-carbon bond, preferably selected from the group of acetylenic alcohols, α,β-unsaturated aldehydes, and/or α-alkenyl phenones, as organic corrosion inhibiting compound,
   as corrosion inhibitor reducing or inhibiting corrosion of metal equipment being present during acidizing treatment in gas- or oilfield reservoirs with one or more acids.

Organic corrosion inhibiting compounds according to this invention which show enhanced corrosion inhibition effectiveness in combination with synthetic polymers include organic compounds having at least one unsaturated carbon-carbon bond, preferably such organic compounds are selected from the group of
(i) acetylenic alcohols, preferably propargyl alcohol, 1-octyn-3-ol, 1 hexyn-3-ol, or 2-methyl-3-butynol,
(ii) α,β-unsaturated aldehydes, preferably cinnamaldehyde, p-methyl-cinnamaldehyde, p-hydroxy-cinnamaldehyde, p-methoxy-cinnamaldehyde, crotonaldehyde, or 2-hexenal,
(iii) α-alkenyl phenones, preferably phenyl vinyl ketone, 2-benzoyl-3-hydroxy-1-propene, or 2-benzoly-3-methoxy-1-propene.

The synthetic polymer used in the present invention preferably contains

(I) at least structural units of formula (I)

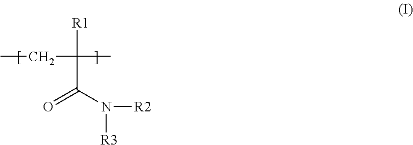

wherein
R1, R2 and R3 independently are hydrogen or C₁-C₆-alkyl,

(II) from 0 to 95% by weight structural units of formula (II)

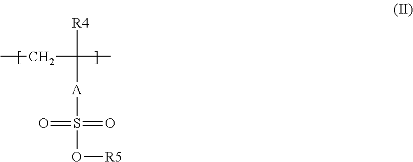

wherein
R4 is hydrogen or C₁-C₆-alkyl,
R5 is hydrogen, a cation of an alkaline metal, of an earth alkaline metal, of ammonia and/or of an organic amine,
A is a covalent C—S bond or a two-valent organic bridging group,

(III) from 0 to 95% by weight structural units of formula (III)

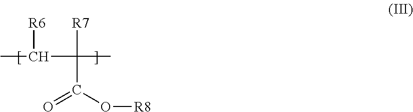

wherein
R6 and R7 are independently of one another hydrogen, C₁-C₆-alkyl, —COOR₉ or —CH₂—COOR₉, with R₉ being hydrogen, a cation of an alkaline metal, of an earth alkaline metal, of ammonia and/or of an organic amine,
R8 is hydrogen, a cation of an alkaline metal, of an earth alkaline metal, of ammonia and/or of an organic amine, or is C₁-C₆-alkyl, a group —CₙH₂ₙ—OH with n being an integer between 2 and 6, preferably 2, or is a group —CₒH₂ₒ—NR10R11, with o being an integer between 2 and 6, preferably 2, and R10 and R11 are independently of one another hydrogen or C₁-C₆-alkyl, preferably hydrogen,

(IV) from 0 to 95% by weight structural units of formula (IV)

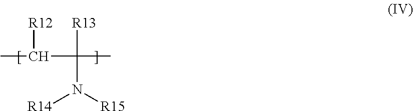

wherein
R12 and R13 are independently of one another hydrogen, C₁-C₆-alkyl, —COOR₁₆ or —CH₂—COOR₁₆, with R₁₆ being hydrogen, a cation of an alkaline metal, of an earth alkaline metal, of ammonia and/or of an organic amine,
R14 is hydrogen or, C₁-C₆-alkyl, and
R15 is —COH, —CO—C₁-C₆-alkyl or R14 and R15 together with the nitrogen atom to which they are attached form a heterocyclic group with 4 to 6 ring atoms, preferably a pyridine ring, a pyrrolidone ring or a caprolactame ring,

(V) from 0 to 20% by weight structural units of formula (V)

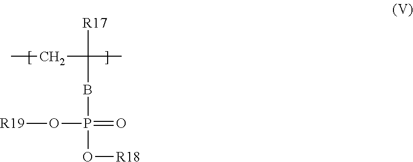

wherein
R17 is hydrogen or, C₁-C₆-alkyl, and
R18 and R19 are independently of one another hydrogen, a cation of an alkaline metal, of an earth alkaline metal, of ammonia and/or of an organic amine,
B is a covalent C—P bond or a two-valent organic bridging group,
with the proviso that the percentage of the structural units of formulae (I) to (V) refer to the total mass of the copolymer and the percentage of the structural units of formulae (I) to (V) amounts to 100%.

In the synthetic polymer the radicals have the following meanings:

The C₁-C₆-alkyl groups being present may be straight-chain or branched. Examples of alkyl groups are methyl, ethyl, n-propyl, iso-propyl, n-butyl, sec.-butyl, tert.-butyl, n-pentyl or n-hexyl. Ethyl and especially methyl are preferred. The group A may be a C—S-covalent bond or a two-valent organic group. Examples thereof are C₁-C₆-alkylene groups or —CO—C₁-C₆-alkylene groups. The alkylene groups may be straight-chain or branched. Examples of A groups are —CₚH₂ₚ— groups or —CO—NH—CₚH₂ₚ— groups, with p being an integer between 1 and 6. —CO—NH—C(CH₃)₂—CH₂— or a C—S-covalent bond is a preferred group A. The group B may be a C—P-covalent bond or a two-valent organic group. Examples thereof are C₁-C₆-alkylene groups. These groups may be straight-chain or branched. Examples of alkylene groups are —C_{q}H_{2q}— groups, with q being an integer between 1 and 6. Methylene or a C—P-covalent bond is a preferred group B.

The structural units of formula (I) are derived from an ethylenically unsaturated carboxylic acid amide selected from the group of acrylamide, methacrylamide and/or their N—C₁-C₆-alkyl derivatives or N,N—C₁-C₆-dialkyl derivatives.

Preferred polymers used in the instant invention further contain structural units of formula (II) to (V) which are derived from an ethylenically unsaturated sulfonic acid and/or its alkaline metal salts and/or their ammonium salts, from ethylenically unsaturated carboxylic acid and/or its alkaline metal salts and/or their ammonium salts, from N-vinylamides, and/or an ethylenically unsaturated phosphonic acid and/or its alkaline metal salts and/or their ammonium salts, optionally together with further copolymerisable monomers.

Other preferred copolymers used in the instant invention are those, wherein B is a C—P covalent bond or a —C_{q}H_{2q}— group with q being an integer between 1 and 6, preferably 1, and/or wherein A is a C—S covalent bond or a —CO—NH—CₚH₂ₚ-group with p being an integer between 1 and 6, preferably between 2 and 4, B being most preferably a group —CO—NH—C(CH₃)₂—CH₂—.

Also preferably applied are copolymers with structural units of the formula (II) derived from vinylsulfonic acid, 2-acrylamido-2-methylpropane sulfonic acid, 2-methacrylamido-2-methylpropane sulfonic acid, styrene sulfonic acid and/or their alkaline metal salts and/or their ammonium salts. Especially preferred are structural units of the formula (II) derived from 2-acrylamido-2-methylpropane sulfonic acid and/or from 2-methacrylamido-2-methylpropane sulfonic acid and/or from their alkaline metal salts and/or from their ammonium salts.

Further preferably applied monomers which are optionally used in the manufacture of the copolymers are chosen from ethylenically unsaturated carboxylic acid and/or their derivatives of the formula (III), preferably chosen from the group of alkylesters from ethylenically unsaturated carboxylic acid, oxyalkylesters of ethylenically unsaturated carboxylic acid and/or esters of ethylenically unsaturated carboxylic acids with N-dialkylalkanolamines.

The ethylenically unsaturated carboxylic acids of the formula (III) are preferably acrylic acid, methacrylic acid, fumaric acid, maleic acid, itaconic acid and/or crotonic acid as well as their alkaline metal salts and/or their ammonium salts. The alkylesters of ethylenically unsaturated carboxylic acids are preferably alkylesters of acrylic acid, methacrylic acid, fumaric acid, maleic acid, itaconic acid and/or crotonic acid. Especially preferred are alkylesters with 1 to 6 carbon atoms. The oxyalkylesters of an ethylenically unsaturated carboxylic acids of the formula (III) are preferably 2-hydroxyethylester of acrylic acid, methacrylic acid, fumaric acid, maleic acid, itaconic acid and/or crotonic acid.

The ester of ethylenically unsaturated carboxylic acid of the formula (III) with N-dialkylalkanolamine is preferably N,N-dimethylethanolamine methacrylate, its salt or quaternary ammonium product.

Further preferably applied copolymers with structural units of the formula (IV) are derived from N-vinylamides.

The N-vinylamide is preferably N-vinylformamide, N-vinylacetamide, N-vinyl-N-methylacetamide, or N-vinylamide comprising cyclic N-vinylamide groups, preferably derived from N-vinylpyrrolidone, N-vinylcaprolactame or N-vinylpyridine. Preferably applied are copolymers with structural units of the formula (V) are derived from vinylphosphonic acid and/or its alkaline metal salts and/or its ammonium salts, and/or allylphosphonic acid and/or its alkaline metal salts and/or its ammonium salts.

Preferred copolymers used in the instant invention are those, wherein R₁, R₂, R₃, R₄, R₁₀, R₁₁, R₁₄, and R₁₇ are independently of one another hydrogen or methyl or wherein R₅, R₉, R₁₆, R₁₈ and R₁₉ are independently of one another hydrogen or a cation of an alkali metal, of an earth alkaline metal, of ammonia or of an organic amine.

Still other preferred copolymers used in the instant invention are those, wherein R₆ and R₁₂ is hydrogen and R₇ and R₁₃ is hydrogen or methyl, or wherein R₆ is —COOR₉ and R₇ is hydrogen or wherein R₆ is hydrogen and R₇ is —CH₂—COOR₉ or wherein R₁₂ is hydrogen and R₁₃ is hydrogen or methyl, or wherein R₁₂ is —COOR₁₆ and R₁₃ is hydrogen or wherein R₁₂ is hydrogen and R₁₃ is —CH₂—COOR₁₆.

Preferred copolymers used in the instant invention are selected from the group consisting of polymers containing:
(i) 10 to 90% by weight of structural formula I, preferred from 20 to 70% by weight,
(ii) 0 to 80% by weight of structural formula II, preferred from 10 to 60% by weight,
(iii) 0 to 50% by weight of structural formula III, preferred from 0 to 40% by weight,
(iv) 0 to 50% by weight of structural formula IV, preferred from 0 to 40% by weight,
(v) 0 to 20% by weight of structural formula V, preferred from 0 to 5% by weight,
referred to the total mass of the polymer.

The copolymer used in the instant invention may be linear or branched or crosslinked either by covalent or ionic crosslinking.

The average molecular weight of the copolymers used according to the invention is higher than 500,000 Dalton, preferably higher than 2,000,000 Dalton.

The average molecular weight can be determined via gel permeation chromatography (GPC). Commercially available polymers, e.g. from acrylamide with molecular weight of 1,140,000 Dalton and 5,550,000 Dalton, can be used as standards. For separation of the sample, a column consisting of a polyhydroxymethacrylate copolymer network with a pore volume of 30,000 Angstrom (A) can be used.

The K value according to Fikentscher serves as indicator for the average molecular weight of the copolymers according to the invention.

The K value of the copolymers used according to the invention is higher than 300 determined as 0.1 weight % copolymer concentration in solvent solution consisting of 0.5% by weight of isotridecanethoxylate (6 EO) surfactant in deionized water, preferably is higher than 350.

The term water soluble synthetic polymer within the meaning of the instant invention means a synthetic polymer having a solubility in water (determined at 23° C.) of at least 5 WI.

The polymers can be synthesized by various technologies, e.g. by inverse emulsion polymerization, gel polymerization or precipitation polymerization.

Organic corrosion inhibiting compounds according to this invention which show enhanced corrosion inhibition effectiveness in combination with synthetic polymers include at least one compound selected from the group of
(i) acetylenic alcohols, preferably propargyl alcohol, 1-octyn-3-ol, 1 hexyn-3-ol, or 2-methyl-3-butynol,
(ii) α,β-unsaturated aldehydes, preferably cinnamaldehyde, p-methyl-cinnamaldehyde, p-hydroxy-cinnamaldehyde, p-methoxy-cinnamaldehyde, crotonaldehyde, or 2-hexenal,
(iii) α-alkenyl phenones, preferably phenyl vinyl ketone, 2-benzoyl-3-hydroxy-1-propene, or 2-benzoly-3-methoxy-1-propene.

A viscosified treatment fluid is prepared by dissolving a solid polymer or by diluting a polymer solution or by inverting a water-in-oil polymer emulsion using water or an acidic aqueous solution.

Typically, the acid used in the acidizing treatment of the instant invention consist of Brønsted acids, such as
(i) inorganic, not oxidizing acids, for example hydrochloric acid or hydrofluoric acid,
(ii) organic mono- and/or dicarboxylic acids, hydroxyl carboxylic acids, for example acetic acid, formic acid, lactic acid, maleic acid,
(iii) alkyl sulfonic acids, for example methansulfonic acid,
and mixtures of the aforementioned acids.

The total concentration of the one or more acid(s), such as Brønsted acids, is typically from 0.1 to 40% by weight, preferred from 1 to 25% by weight and most preferred from 3 to 20% by weight, referred to the mass of treatment fluid.

Typically, hydrofluoric acid is used only in combination with other acids, in particular inorganic acids. The amount of hydrofluoric acid in such acid mixture varies from 0 to 5% by weight. The amount of the other acids typically ranges from 1 to 40% by weight.

The acid(s) may further contain additives that are necessary for the treatment. Typically, those additives may include surfactants and/or biocides.

The concentration of the synthetic polymer is typically from 0.01 to 10% by weight, preferred from 0.05 to 5% by weight and most preferred from 0.2 to 2% by weight, referred to the mass of treatment fluid.

To increase the viscosity of the treatment fluid, the polymers may also be ionically crosslinked by multivalent metal ions or metal complexes selected from group IIIA, IVB, VB, VIB, IIVB and/or VIIIB of the periodic table of elements, preferably selected form the ions and/or complexes of zirconium, aluminium, titanium, boron, chromium and/or iron. Especially preferred are the ions and/or complexes of zirconium and titanium.

Typically water soluble salts of the multivalent metal ions are used. Suitable anions are e.g. halides, especially chloride, sulfate, lactate, citrate or gluconate. Also suitable are complexes of the multivalent metal ions with organic N- and O-compound, e.g. alcohols, di- and triols, mono-, di- and tri-carboxylic acids, mono-, di- and triamines and/or hydroxyalkylamines.

The quantity of transition metal compound for crosslinking the polymers ranges 0.1 to 50% by weight, preferred from 0.5 to 30%, more preferred from 1 to 20% by weight, referred to the total mass of polymer.

The transition metal compounds, e.g. the salts and/or complexes of transition metal cation, are dissolved and/or diluted in water or in a water miscible solvent, and then added to the polymer solution under stirring to ensure a homogenous distribution of transition metal cation in the solution. The crosslinking of the polymer chains can be retarded or speeded up by adaptation of the stirring speed and/or adjusting the temperature.

The viscosity of the viscosified acids or of the crosslinked hydrogels typically may range from about 3 mPas to 5000 mPas, preferred from 10 to 500 mPas.

The concentration of the organic corrosion inhibiting compound which is preferably selected from the groups of acetylenic alcohols, α,β-unsaturated aldehydes, and/or α-alkenyl phenones, is typically from 0.001 to 5% by weight, preferred from 0.05 to 2% by weight, referred to the mass of treatment fluid.

Another aspect of the instant invention is a method for reducing or inhibiting corrosion of steel equipment being present during an acid treatment of a gas- or oilfield reservoir with one or more acids comprising the measures:
(i) providing an aqueous viscosified treatment fluid containing at least an acid, and a water soluble synthetic polymer
   and
   at least one corrosion inhibiting compound
(ii) pumping the treatment fluid into the formation using steel equipment, characterised in that
(iii) the synthetic polymer is a polymer comprising ethylenically unsaturated carboxylic, sulfonic or phosphonic acids, their esters, unsubstituted or N- and N,N-substituted derivatives of amides of ethylenically unsaturated carboxylic acids, N-substituted (cyclic) derivatives of ethylenically unsaturated amides and
(iv) the corrosion inhibiting compound is an organic compound having at least one unsaturated carbon-carbon bond, preferably selected from the group of acetylenic alcohols, α,β-unsaturated aldehydes, and/or α-alkenyl phenones.

Preferably the synthetic polymer used in the instant invention comprises

(I) at least structural units of formula (I)

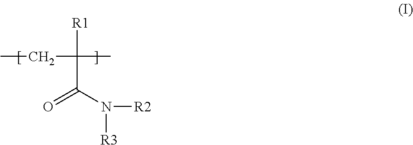

wherein
R1, R2 and R3 independently are hydrogen or C₁-C₆-alkyl,

(II) from 0 to 95% by weight structural units of formula (II)

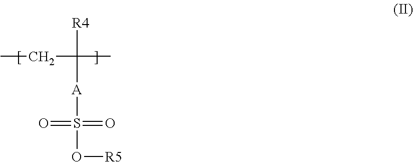

wherein
R4 is hydrogen or C₁-C₆-alkyl,
R5 is hydrogen, a cation of an alkaline metal, of an earth alkaline metal, of ammonia and/or of an organic amine,
A is a covalent C—S bond or a two-valent organic bridging group,

(III) from 0 to 95% by weight structural units of formula (III)

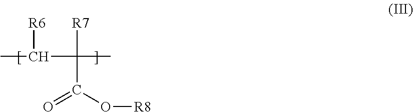

wherein
R6 and R7 are independently of one another hydrogen, C₁-C₆-alkyl, —COOR₈ or —CH₂—COOR₉, with R₉ being hydrogen, a cation of an alkaline metal, of an earth alkaline metal, of ammonia and/or of an organic amine,
R₈ is hydrogen, a cation of an alkaline metal, of an earth alkaline metal, of ammonia and/or of an organic amine, or is C₁-C₆-alkyl, a group —CₙH₂ₙ—OH with n being an integer between 2 and 6, preferably 2, or is a group —Cₒ—H₂ₒ—NR10R11, with o being an integer between 2 and 6, preferably 2, and R10 and R11 are independently of one another hydrogen or C₁-C₆-alkyl, preferably hydrogen,

(IV) from 0 to 95% by weight structural units of formula (IV)

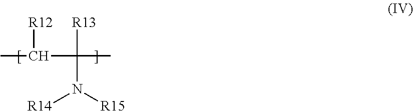

wherein
R12 and R13 are independently of one another hydrogen, C₁-C₆-alkyl, —COOR₁₆ or —CH₂—COOR₁₆, with R₁₆ being hydrogen, a cation of an alkaline metal, of an earth alkaline metal, of ammonia and/or of an organic amine,
R14 is hydrogen or, C₁-C₆-alkyl, and
R15 is —COH, —CO—C₁-C₆-alkyl or
R14 and R15 together with the nitrogen atom to which they are attached form a heterocyclic group with 4 to 6 ring atoms, preferably a pyridine ring, a pyrrolidone ring or a caprolactame ring,

(V) from 0 to 20% by weight structural units of formula (V)

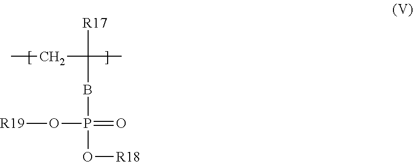

wherein
R17 is hydrogen or, C₁-C₆-alkyl, and
R18 and R19 are independently of one another hydrogen, a cation of an alkaline metal, of an earth alkaline metal, of ammonia and/or of an organic amine,
B is a covalent C—P bond or a two-valent organic bridging group,
with the proviso that the percentage of the structural units of formulae (I) to (V) refer to the total mass of the copolymer and the percentage of the structural units of formulae (I) to (V) amounts to 100%

The presence of the aforementioned synthetic polymer, in particular comprising the structural units (I) to (V), in combination with the aforementioned organic corrosion inhibiting compound having at least one unsaturated carbon-carbon bond, preferably selected from the group of acetylenic alcohols, α,β-unsaturated aldehydes, and/or α-alkenyl phenones reduces the corrosion of steel equipment during an acidizing treatment significantly and provide enhanced corrosion inhibition effectiveness than do compositions either with synthetic polymers or individual corrosion inhibitor compounds alone. Thus, one can say that such mixtures provide a synergistic effect.

Test Methods

The following testing methods are used:

Viscosity:

The viscosity was determined using a Fann 35 rheometer or Ubbelohde capillary viscosimeter.

The Fann 35 rheometer is a Couette type coaxial cylinder rotational viscometer, equipped with R1 rotor sleeve, B1 bob and F1 torsion spring. 120 ml of the sample were poured into the viscometer cup and characterized at 100 rpm and room temperature.

For the Ubbelohde capillary viscosimeter the capillary of appropriate width was chosen, about 30 ml of the sample were filled into the capillary. The capillary was then allowed to adjust temperature to 30° C. for 10 min in a water bath. The time of the defined sample volume for passing through the capillary was taken and then multiplied with the capillary constant to give the viscosity in cP.

### K Value

The K-value is a method to determine the molecular mass of polymers relative to a sample of similar chemical composition.

To determine the K value, the copolymer is dissolved in a 0.5% by weight solution of isotridecanethoxylate (6 EO) surfactant in distilled water. The quantity of copolymer in the solution is adjusted to 0.1% by weight and added to the solvent solution under stirring.

The viscosities of the solvent solution no as well as of the copolymer solution η_{c} are determined by means of an Ubbelohde capillary viscometer at 25° C. This value gives the absolute viscosity of the solution (η_{c}). The absolute viscosity of the solvent is no. The ratio of the two absolute viscosities gives the relative viscosity ηᵣₑₗ.

nᵣₑₗ=η_{c}/ηₒ

From the relative viscosity, the K value can be determined as a function of the concentration c by means of the following equations:

Log ηᵣₑₗ=[(75k²/(1+1.5kc)+k]c

k=K/1000

### Corrosion Test:

The corrosion tests were performed at different temperatures. Small metal specimen—about 12 g each—of different steel quality were purchased. To remove any coating and to create a clean and well defined surface, the specimens were pre etched for 2 h using HCl 15% by weight. All steel specimens were cleaned carefully with alkaline surfactant solution, then with distilled water followed by acetone. The specimens were allowed to dry at the air. They were not touched with the hand, only by using forceps.

Directly before the start of a test the weight of the specimen was determined. 200 ml of acid solution were prepared for every corrosion test. The acid solution contained different concentration of synthetic polymer and/or organic corrosion inhibiting compound. For reference purposes, aqueous acid of the same concentration without corrosion inhibitor were also used. The acidic solutions were poured in a flask equipped with a reflux condenser and a magnetic stirrer bar and then heated under stirring in an oil bath to the desired temperature. At the test temperature the specimen was placed into the test solution. After a defined time the specimen was removed and purged with alkaline surfactant solution, distilled water and acetone. After drying at the air the weight of the specimen was determined and the weight loss relative to the initial weight was calculated.

### Abbreviations

HLB HLB-value means the hydrophilic-lipophilic balance of a surfactant and is a measure of the degree to which it is hydrophilic or lipophilic, determined by calculating values for the different regions of the molecule. There are different methods to calculate the HLB-value. The most common results in a ranking of the surfactants between 0 and 20 with 0 corresponds to a completely lipophilic/hydrophobic molecule, and a value of 20 corresponds to a completely hydrophilic/lipophobic molecule. Typically, the suppliers specifies the HLB-value of the surfactant.
St37 St37 is the designation for an unalloyed carbon steel for construction purposes.
1.4301 1.4301 is the designation for an alloy steel containing 18% by weight Cr and 5% by weight Ni.
1.4401 1.4401 is the designation for an alloy steel containing 16% by weight, Cr 10% by weight Ni and 2% by weight Mo.
ηₒ Viscosity of solvent solution for K value determination
η_{c} Viscosity of copolymer solution for K value determination
ηᵣₑₗ Relation of η_{c} relative to ηₒ
c Concentration of polymer in solution, determination of K value

The following examples illustrate the invention without limiting it.

### EXAMPLES

### Example 1: Preparation of a Polymer Via Inverse Emulsion Polymerization

37 g sorbitan monooleate were dissolved in 160 g isoparaffin. 100 g water in a beaker were cooled to 5° C., then 50 g 2-acrylamido-2-methylpropane sulfonic acid and 10 g vinylphosphonic acid were added. The pH was adjusted to 7.1 with aqueous ammonia solution. Subsequently 223 g acryl amide solution (60 weight % in water) were added.

Under vigorous stirring the aqueous monomer solution was added to the isoparaffin mixture. The emulsion was then purged for 45 min with nitrogen. The polymerization was started by addition of 0.5 g azoisobutyronitrile in 12 g isoparaffin and heated to 50° C. To complete the reaction the temperature was increased to 80° C. and maintained at this temperature for 2 h. The polymer emulsion was cooled to room temperature. As product, a viscous fluid was obtained.

The K-value of the copolymer of ex. was 390.

### Example 2: Preparation of a Polymer Via Inverse Emulsion Polymerization

A polymer emulsion was prepared according to example 1 but using 80 g 2-acrylamido-2-methylpropane sulfonic acid, no vinylphosphonic acid and 187.5 g acryl amide solution (60 weight % in water).

The K-value of the copolymer of ex. 2 was 441.

### Example 3: Preparation of a Polymer Via Gel Polymerization

400 ml deionized water and 9.2 ml 25 weight-% aqueous ammonia solution were placed in a reaction vessel. 70 g acryl amide and 30 g acrylic acid were added under stirring. The solution was purged with nitrogen and heated to 50° C. The polymerization was started by addition of 5 ml of a 20% by weight aqueous solution of ammonium persulfate. To complete the reaction the temperature was increased to 80° C. and maintained at this temperature for 2 h. After cooling to room temperature a highly viscous gel was obtained. The gel was dried at 90° C. in a vacuum drying oven and carefully chopped from time to time. The dried polymer was crushed to obtain small particles.

The K-value of the copolymer of ex. 3 was 418.

### Examples 4 to 12

To prepare the acidic solution from inverse polymer emulsion, 1.5 g isotridecan ethoxylate (6 EO) surfactant were added to 150 g of hydrochloric acid in a Waring blender. Then, polymer emulsion and/or organic corrosion inhibiting compound were added and mixed for 4 min.

To prepare the acidic solution from solid polymer, the polymer powder and/or the organic corrosion inhibiting compound were added to 150 g hydrochloric acid in a Waring blender and mixed for 10 min. Then solution was poured into a beaker and stirred overnight slightly using a magnetic bar stirrer.

Tests were conducted at 90° C. for 3 h. The concentrations of hydrochloric acid, synthetic polymer and the organic corrosion inhibiting compound as well as the results are given in table 2.

TABLE 2

| | | | Polymer or | | | | Conc. Of | |
|---|---|---|---|---|---|---|---|---|
| | | | polymer | Conc. | Conc. | | inhibitor | |
| Example | Steel | HCl, % | emulsion | polymer, % | emulsion, % | Compound | compound, % | Weight loss, % |
| 4 ref | 1.4301 | 15 | — | — | — | — | — | 30.4 |
| 5 | 1.4301 | 15 | Ex. 1 | — | 2.2 | — | — | 9.6 |
| 6 | 1.4301 | 15 | Ex. 1 | — | 0.6 | Propargyl | 0.05 | 2.5 |
| | | | | | | alcohol | | |
| 7 | 1.4301 | 15 | — | — | — | Propargyl | 0.05 | 7.2 |
| | | | | | | alcohol | | |
| 8 | 1.4301 | 15 | — | — | — | Cinnamaldehyde | 0.3 | 8.9 |
| 9 | 1.4301 | 15 | Ex. 1 | — | 0.6 | Cinnamaldehyde | 0.3 | 1.0 |
| 10 | 1.4301 | 15 | Ex. 2 | | 2.2 | Propargyl | 0.05 | 0.8 |
| | | | | | | alcohol | | |
| 11 | 1.4301 | 15 | Ex. 2 | | 2.2 | Propargyl | 0.3 | 0.08 |
| | | | | | | alcohol | | |
| 12 | 1.4301 | 15 | Ex. 3 | 0.6 | | Propargyl | 0.3 | 2.3 |
| | | | | | | alcohol | | |

Concentrations of HCl, polymer powder and polymer emulsion are given in % by weight relative to the total mass of the acidic test solution.

The weight loss of steel specimen is given in % by weight relative to the initial weight of the specimen before testing.

The examples clearly show that steel is significantly less attacked by hydrochloric acid in various concentrations when polymers according to the invention are present compared to reference tests where hydrochloric acid without polymers were used. Organic corrosion inhibiting compound according to the invention also clearly reduces acid corrosion even at low concentration. The combination of synthetic polymer and corrosion inhibiting compounds significantly enhances the corrosion inhibiting efficiency against acidic attack.

The corrosion inhibition effect is obvious even at very low concentration of polymer.

1. A corrosion inhibitor is an aqueous mixture comprising
(i) water and
(ii) a mixture consisting of
(iia) water soluble synthetic polymer comprising ethylenically unsaturated carboxylic, sulfonic or phosphonic acids, their esters, unsubstituted or N- and N,N-substituted derivatives of amides of ethylenically unsaturated carboxylic acids, N-substituted (cyclic) derivatives of ethylenically unsaturated amides and
(iib) at least of one organic compound having at least one unsaturated carbon-carbon bond as organic corrosion inhibiting compound,
whereby the corrosion inhibitor reduces or inhibits corrosion of metal equipment present during acidizing treatment in gas or oilfield reservoirs with one or more acids.

2. The corrosion inhibitor of claim 1 wherein the water soluble synthetic polymer comprising
(I) at least structural units of formula (I) 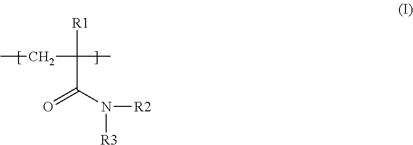
wherein
R1, R2 and R3 independently are hydrogen or C₁-C₆-alkyl,
(II) from 0 to 95% by weight structural units of formula (II) 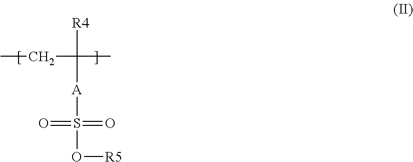
wherein
R4 is hydrogen or C₁-C₆-alkyl,
R5 is hydrogen, a cation of an alkaline metal, of an earth alkaline metal, of ammonia and/or of an organic amine,
A is a covalent C—S bond or a two-valent organic bridging group,
(III) from 0 to 95% by weight structural units of formula (III) 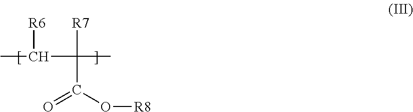
wherein
R6 and R7 are independently of one another hydrogen, C₁-C₆-alkyl, —COOR₉ or —CH₂—COOR₉, with R₉ being hydrogen, a cation of an alkaline metal, of an earth alkaline metal, of ammonia and/or of an organic amine,
R8 is hydrogen, a cation of an alkaline metal, of an earth alkaline metal, of ammonia and/or of an organic amine, or is C₁-C₆-alkyl, a group —CₙH₂ₙ—OH with n being an integer between 2 and 6, or is a group —CₒH₂ₒ—NR10R11, with o being an integer between 2 and 6, and R10 and R11 are independently of one another hydrogen or C₁-C₆-alkyl,
(IV) from 0 to 95% by weight structural units of formula (IV) 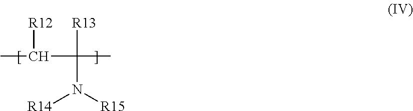
wherein
R12 and R13 are independently of one another hydrogen, C₁-C₆-alkyl, —COOR₁₆ or —CH₂—COOR₁₆, with R₁₆ being hydrogen, a cation of an alkaline metal, of an earth alkaline metal, of ammonia and/or of an organic amine,
R14 is hydrogen or, C₁-C₆-alkyl, and
R15 is —COH, —CO—C₁-C₆-alkyl or
R14 and R15 together with the nitrogen atom to which they are attached form a heterocyclic group with 4 to 6 ring atoms,
(V) from 0 to 20% by weight structural units of formula (V) 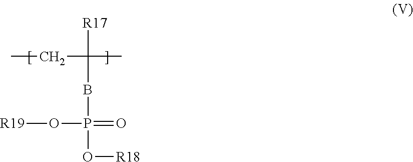
wherein
R17 is hydrogen or, C₁-C₆-alkyl, and
R18 and R19 are independently of one another hydrogen, a cation of an alkaline metal, of an earth alkaline metal, of ammonia and/or of an organic amine,
B is a covalent C—P bond or a two-valent organic bridging group,
with the proviso that the percentage of the structural units of formulae (I) to (V) refer to the total mass of the copolymer and the percentage of the structural units of formulae (I) to (V) amounts to 100%.

3. The corrosion inhibitor of claim 2, wherein the water soluble synthetic polymer material is selected from the group consisting of polymers containing:
(I) 10 to 90% by weight of structural formula I,
(II) 0 to 80% by weight of structural formula II,
(III) 0 to 50% by weight of structural formula III,
(IV) 0 to 50% by weight of structural formula IV,
(V) 0 to 20% by weight of structural formula V,
referred to the total mass of the polymer.

4. The corrosion inhibitor of claim 2 wherein the structural units of formula (I) are obtained from an ethylenically unsaturated carboxylic acid amide selected from the group of acrylamide, methacrylamide and/or their N—C₁-C₆-alkyl derivatives or N,N—C₁-C₆-dialkyl derivatives.

5. The corrosion inhibitor of claim 2 wherein the polymer contain structural units of formula (II) to (V) which are obtained from an ethylenically unsaturated sulfonic acid and/or its alkaline metal salts and/or their ammonium salts, from ethylenically unsaturated carboxylic acid and/or its alkaline metal salts and/or their ammonium salts, from N-vinylamides, and/or an ethylenically unsaturated phosphonic acid and/or its alkaline metal salts and/or their ammonium salts, optionally together with further copolymerisable monomers.

6. The corrosion inhibitor of claim 2 wherein the polymer is a copolymer with structural units of the formula (II) obtained from vinylsulfonic acid, 2-acrylamido-2-methylpropane sulfonic acid, 2-methacrylamido-2-methylpropane sulfonic acid, styrene sulfonic acid and/or their alkaline metal salts and/or their ammonium salts.

7. The corrosion inhibitor of claim 2 wherein the polymer is a copolymer with structural units of the formula (III) obtained from ethylenically unsaturated carboxylic acid and/or their derivatives.

8. The corrosion inhibitor of claim 2 wherein the polymer is a copolymer with structural units of the formula (IV) obtained from N-vinylamide.

9. The corrosion inhibitor of claim 2 wherein the polymer is a copolymer with structural units of the formula (V) being vinylphosphonic acid and/or its alkaline metal salts and/or its ammonium salts, and/or allylphosphonic acid and/or its alkaline metal salts and/or its ammonium salts.

10. The corrosion inhibitor of claim 1 wherein the acid consists of one or more Brønsted acids.

11. The corrosion inhibitor of claim 1 wherein the total concentration of the synthetic polymer is from 0.01 to 10% by weight referred to the mass of treatment fluid.

12. The corrosion inhibitor of claim 1 wherein the viscosity of the treatment fluid is increased by ionically crosslinking the polymer by multivalent metal ions or metal complexes selected from group IIIA, IVB, VB, VIB, IIVB and/or VIIIB of the periodic table of elements.

13. The corrosion inhibitor of claim 1 wherein the viscosity of the treatment fluid is from 3 mPas to 5000 mPas.

14. The corrosion inhibitor of claim 1 wherein the total concentration of the organic corrosion inhibiting compound having at least one unsaturated carbon-carbon bond is from 0.001 to 5% by weight referred to the mass of treatment fluid.

15. The corrosion inhibitor of claim 14, wherein the acetylenic alcohol is propargyl alcohol, 1-octyn-3-ol, 1 hexyn-3-ol, or 2-methyl-3-butynol, the α,β-unsaturated aldehyde is cinnamaldehyde, p-methyl-cinnamaldehyde, p-hydroxy-cinnamaldehyde, p-methoxy-cinnamaldehyde, crotonaldehyde, or 2-hexenal, the α-alkenyl phenon is phenyl vinyl ketone, 2-benzoyl-3-hydroxy-1-propene, or 2-benzoly-3-methoxy-1-propene.

16. The corrosion inhibitor of claim wherein the treatment fluid further contains natural based polymers, polysaccharides or modified polysaccharides.

17. A method for reducing or inhibiting corrosion of steel equipment being present during an acid treatment of a gas- or oilfield reservoir with one or more acids comprising the measures:
(i) providing an aqueous viscosified treatment fluid containing at least an acid,
a water soluble synthetic polymer, and
at least one corrosion inhibiting compound
(ii) pumping the treatment fluid into the formation using steel equipment, characterised in that
(iii) the synthetic polymer is a polymer comprising ethylenically unsaturated carboxylic, sulfonic or phosphonic acids, their esters, unsubstituted or N- and N,N-substituted derivatives of amides of ethylenically unsaturated carboxylic acids, N-substituted (cyclic) derivatives of ethylenically unsaturated amides and
(iv) the corrosion inhibiting compound is an organic compound has at least one unsaturated carbon-carbon bond, preferably selected from the group of acetylenic alcohols, α,β-unsaturated aldehydes, and/or α-alkenyl phenones.

18. The method of claim 17, wherein the water soluble synthetic polymer material is defined in claim 2.

19. The method of claim 17 wherein the corrosion inhibiting compound is defined in claim 14.

20. The corrosion inhibitor of claim 1 wherein at least one unsaturated carbon-carbon bond is selected from the group of acetylenic alcohols, α,β-unsaturated aldehydes, and/or α-alkenyl phenones.
